(19) United States
(12) Patent Application Publication
(10) Pub. No.: US 2025/0389838 A1
(43) Pub. Date: Dec. 25, 2025

(54) OBJECT LOCALISATION

(71) Applicants: Pragmatic Semiconductor Limited, Cambridge (GB); University Of Sheffield, Sheffield (GB)

(72) Inventors: Bobby Andrew ARYA-MANESH, Sheffield (GB); Thomas Sebastian DREZET, Sheffield (GB); Alexandru Cosmin PASCU, Cambridge (GB)

(73) Assignees: Pragmatic Semiconductor Limited, Cambridge (GB); University Of Sheffield, Sheffield (GB)

(21) Appl. No.: 18/878,114

(22) PCT Filed: Jun. 20, 2023
(86) PCT No.: PCT/GB2023/051611

§ 371 Date: Dec. 23, 2024

(30) Foreign Application Priority Data
Jun. 22, 2022 (GB) 2209187.0

(51) Int. Cl. G01S 13/75; B07C 5/34; B65G 43/00; G06K 7/10

(52) U.S. Cl. CPC G01S 13/751; B65G 43/00; G06K 7/10366; B07C 5/3412; B65G 2203/046

(57) ABSTRACT

Apparatus for identifying a position of an object, each object having an associated tag. Signals are received from a tag associated with the object, as the object is conveyed through one or more coverage areas. The coverage areas in which signals have been received from the tag are identified and a position of the object is determined to be a position corresponding to a path through the localisation region that passes through the identified coverage areas.

The present invention relates to methods and apparatus for the localisation of objects. The present invention has particular, but not exclusive, relevance to the localisation of moving objects such as objects located on a moving conveyor. The present invention has particular, but not exclusive, application for localising objects for the purposes of sorting those objects.

The use of radio frequency identification (RFID), based on RFID tags attached to objects, has become a well-known technique for identifying objects to which an RFID tag is attached. RFID has also been used for many years as a way to locate items to which an RFID tag is attached.

A range of techniques have been developed for localisation of items, which may provide an estimate of the position of those items, using RFID, many of which rely on ultra-high-frequency (UHF) RFID technology, and each with its own respective strengths and weaknesses.

Some of the RFID localisation techniques may be classified as received signal strength (RSS) methods.

In one such technique, for example, RFID readers comprise sensors that measure the strength (amplitude) of received signals from active RFID tags. The RFID readers are located at a number of different locations and the signal measurements performed at the readers, for a particular RFID tag, are aggregated to provide a triangulated estimate of a three-dimensional position of the tag based on a complex model of the transmission environment. Whilst this technique can be effective it is relatively complex, and calculation times can be long.

In another similar technique, RFID tag signal strength is compared to that from reference tags at known fixed locations. This approach allows many of the environmental variations that affect other RSS techniques, such as that described above, to be accounted for, albeit at the expense of additional tags and relatively complex calibrations.

Some of the RFID localisation techniques may be classified as signal phase-based methods.

These signal phase-based methods include, for example, Time of Arrival (ToA) techniques in which reader-tag distance is calculated from the time of flight of the signal and the speed of light and therefore some form of reader-tag synchronisation is required.

A variation of the ToA techniques is Time Difference of Arrival (TDoA) technique in which differences between times of arrival are measured at known reference points and synchronisation is therefore not required.

These signal phase-based methods also include Angle of Arrival (AoA) techniques in which tag location is determined using the phase difference between the signals received at different antennas which must be positioned with half a wavelength (typically ˜15 cm) of one another.

Another signal phase-based method is based on the principles of Synthetic Aperture Radar (SAR) and involves measuring phase values for different relative positions of the tag and the reader antenna, and then combining the measurements in the manner of a virtual antenna array.

In the above techniques, and in general, it can be seen that high accuracy localisation using RFID typically requires extensive and complex calibrations and/or modelling, active tags, and/or sophisticated reader installations. This complexity leads to potentially costly solutions and long computation times that are not ideal for many applications, for example applications that require rapid decisions to made based on an object's location.

One application that such techniques are not best suited to is, for example, the localisation of tagged items that are moving through an area covered by the RFID reader(s)—especially where the movement is relatively fast. For example, in applications where tagged items are conveyed past one or more readers (e.g., on a conveyor belt, rollers or the like) for the purposes of downstream sorting of those items, based on an identity obtained by the reader(s), the time taken to identify and accurately locate each item can limit the speed at which the items can be conveyed and hence sorted. Such limitations can be an issue even in relatively straightforward applications in which items are conveyed sequentially, one at a time, past the readers.

The task of identifying and precisely locating a tag, and hence an item to which it is fixed, can be even more challenging in scenarios in which large numbers of tagged objects are spread relatively randomly across the area covered by the reader(s) as they are being transported through that area (e.g., distributed across the entire width of a conveyor). An example of such an application is the separation of waste packaging items being conveyed relatively quickly in mixed streams for the purposes of effective recycling. It will be appreciated, nevertheless, that there are other applications in which such sorting may be desirable.

It can be seen, therefore, that there is a need for improved methods and/or apparatus for the localisation of objects. The invention aims to provide at least one method and/or apparatus that at least partially addresses this need.

In one aspect, the invention comprises, apparatus for identifying a position of a given object of a plurality of objects being conveyed in a direction of travel through a localisation region, each object having an associated tag, the apparatus comprising: means for receiving signals from a respective tag associated with each object, as that object is conveyed through the localisation region, wherein the means for receiving is configured to provide a plurality of coverage areas and to receive the signals from the respective tag associated with that object when that object follows a path, of a plurality of possible paths through the localisation region, that passes through at least one coverage area of the plurality of coverage areas; means for identifying at least one coverage area of the plurality of coverage areas in which signals have been respectively received from the tag associated with the given object; and means for determining a position of the given object to be a position corresponding to a path, of the respective plurality of possible paths through the localisation region, that passes through the at least one coverage area identified by the identifying means; wherein at least two paths, of the plurality of possible paths, respectively pass through each coverage area of the plurality of coverage areas, and wherein the means for determining is configured to differentiate between the at least two paths, that respectively pass through each coverage area of the at least one coverage area identified by the identifying means, to determine the position of the given object.

The means for receiving may be configured to provide the plurality of coverage areas in an arrangement in which each path, of the at least two paths that respectively pass through each coverage area, passes through an associated combination of one or more coverage areas of the plurality of coverage areas. The means for determining may be configured to determine the position of the given object to be a path of the at least two paths that has an associated combination of one or more coverage areas that is the same as the at least one coverage area identified by the identifying means. The means for receiving may be configured to provide the plurality of coverage areas in an arrangement in which at least one path, of the at least two paths that respectively pass through each coverage area, passes through an associated combination of at least two coverage areas. The means for receiving may be configured to provide the plurality of coverage areas in an arrangement in which at least one path, of the at least two paths that respectively pass through each coverage area, passes through an associated combination comprising a single coverage area. The means for receiving may be configured to provide the plurality of coverage areas in an arrangement in which a first at least one coverage area is offset, in a direction orthogonal to the direction of travel, from a second at least one coverage area, by an offset distance that is less than a dimension of the first at least one coverage area in the direction orthogonal to the direction of travel. The means for receiving may be configured to provide the first at least one coverage area and the second at least one coverage area in a manner in which the first at least one coverage area and the second at least one coverage area do not overlap spatially with one another. Thee means for receiving may be configured to provide the first at least one coverage area and the second at least one coverage area in a manner in which the first at least one coverage area and the second at least one coverage area do not overlap spatially with one another by providing the first at least one coverage area and the second at least one coverage area in an arrangement in which the first at least one coverage area and the second at least one coverage area are spatially separated in the direction of travel. The means for receiving may be configured to provide the first at least one coverage area and the second at least one coverage area in a manner in which the first at least one coverage area and the second at least one coverage area do not overlap spatially with one another by separating provision of the first at least one coverage area and of the second at least one coverage area in time. The means for receiving may be configured to provide the plurality of coverage areas in an arrangement in which the first at least one coverage area comprises a plurality of coverage areas that are spatially separated from one another, in a direction orthogonal to the direction of travel, by a separation distance that is less than the offset distance. The means for receiving may be configured to provide the plurality of coverage areas in an arrangement in which the offset distance is approximately half the dimension of the first at least one coverage area in the direction orthogonal to the direction of travel.

The means for determining may be configured to determine a respective position of each of the plurality of objects based on information mapping each path, of the plurality of possible paths through the localisation region, to the at least one coverage area of the plurality of coverage areas through which that path passes. The means for determining may be configured to respectively acquire information representing a number of times that a signal is received from the tag associated with the given object as the given object passes through a corresponding coverage area. The means for determining may be configured to differentiate between the at least two paths, that respectively pass through each coverage area of the at least one coverage area identified by the identifying means, based on the number of times that a signal is received from the tag associated with the given object as the given object passes through that coverage area. The means for determining may be configured to determine a respective position of each of the plurality of objects based on information for mapping each path, of the plurality of possible paths through the localisation region, that passes through a corresponding coverage area to a respective range of possible numbers of times that a signal will be received from a tag associated with an object as that object passes through that corresponding coverage area. Each range of possible numbers of times that a signal will be received from a tag associated with an object, as that object passes through that corresponding coverage area, may be delimited by at least one threshold value corresponding to an upper or lower end of the range of possible numbers of times. The means for determining may be configured to determine an orientation of the object based on the number of times that a signal is received from the tag associated with the given object as the given object passes through that coverage area. The means for determining may be configured to determine the orientation of the object based on information for mapping each orientation, of a plurality of possible orientations, to a respective range of possible numbers of times that a signal will be received from a tag associated with an object as that object passes through a corresponding coverage area.

The apparatus may further comprise means for reading information carried by the signals received from the respective tag associated with each object of the plurality of objects and for discriminating between the given object and the other objects being conveyed in the direction of travel through the localisation region based on the information carried by the signals received from the respective tag associated with each object. The means for determining may be configured to determine a respective position of each of the plurality of objects and wherein the apparatus further comprises means for generating control signals for sorting the plurality of objects based on the respective information carried by the signals received from the respective tag associated with each object and read by the reading means, and the respective position determined for each object. The apparatus may further comprise means for selectively separating the given object from at least one other object conveyed in the direction of travel through the localisation region based on the discriminating.

The tag may be a radio frequency identification (RFID) tag. The means for receiving may be configured for receiving RFID signals from the RFID tag. The tag may be a passive RFID tag. The means for receiving may be configured to provide each coverage area of the plurality of coverage areas by illuminating the coverage area with an RFID signal for activating the passive RFID tag.

The means for receiving may comprise a plurality of antennas each antenna being configured to provide a respective coverage area of the plurality of coverage areas.

In one aspect, the invention comprises, a method of identifying a position of a given object of a plurality of objects being conveyed in a direction of travel through a localisation region, each object having an associated tag, the apparatus comprising: receiving, at means for receiving, signals from a respective tag associated with each object, as that object is conveyed through the localisation region, wherein the means for receiving is configured to provide a plurality of coverage areas and to receive the signals from the respective tag associated with that object when that object follows a path, of a plurality of possible paths through the localisation region, that passes through at least one coverage area of the plurality of coverage areas; identifying at least one coverage area of the plurality of coverage areas in which signals have been respectively received from the tag associated with the given object; and determining a position of the given object to be a position corresponding to a path, of the respective plurality of possible paths through the localisation region, that passes through the at least one coverage area identified by the identifying means; wherein at least two paths, of the plurality of possible paths, respectively pass through each coverage area of the plurality of coverage areas, and wherein the means for determining is configured to differentiate between the at least two paths, that respectively pass through each coverage area of the at least one coverage area identified by the identifying means, to determine the position of the given object.

Embodiments of the invention will now be described, by way of example, with reference to the accompanying drawings in which:

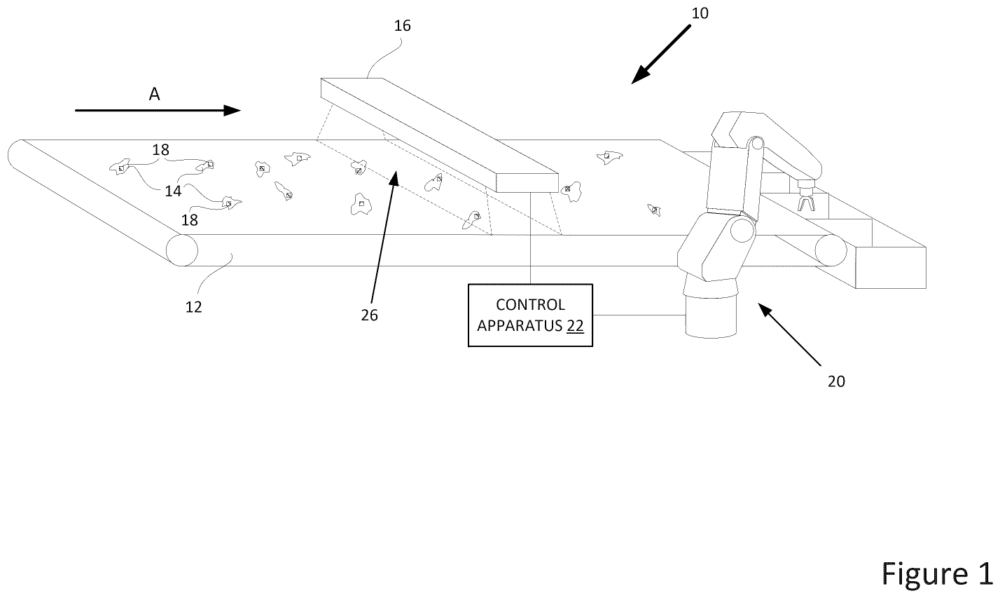

FIG. 1 is a simplified illustration of a system for separating objects;

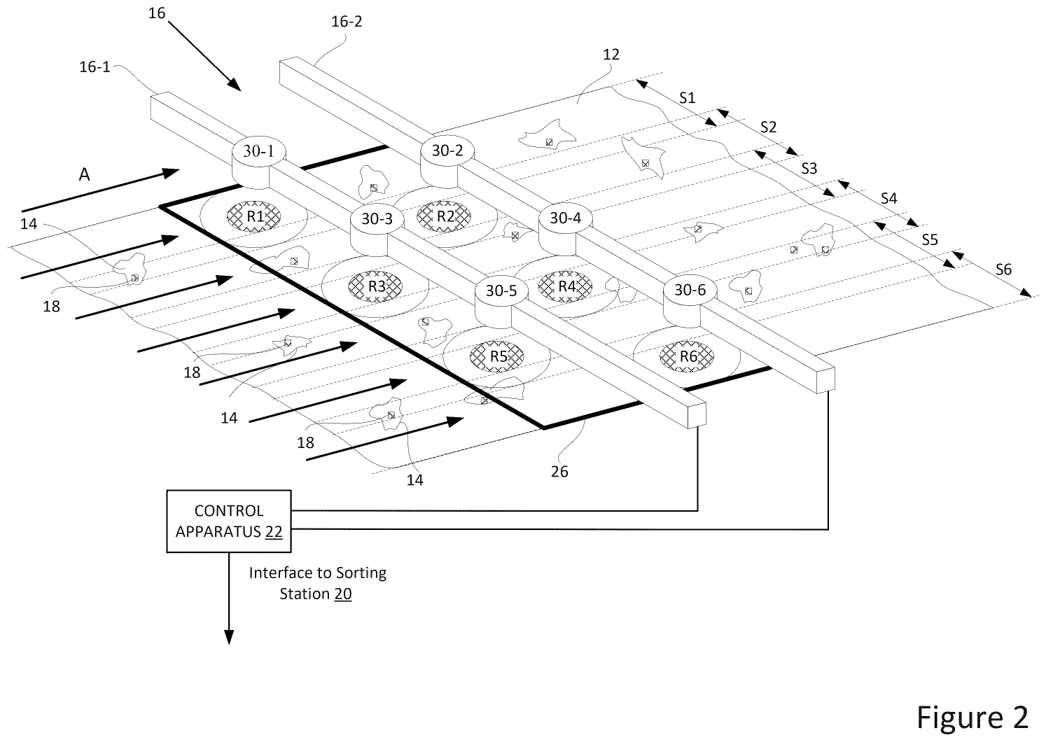

FIG. 2 is a simplified illustration of a possible exemplary arrangement for a reader array that may be used in the system of FIG. 1;

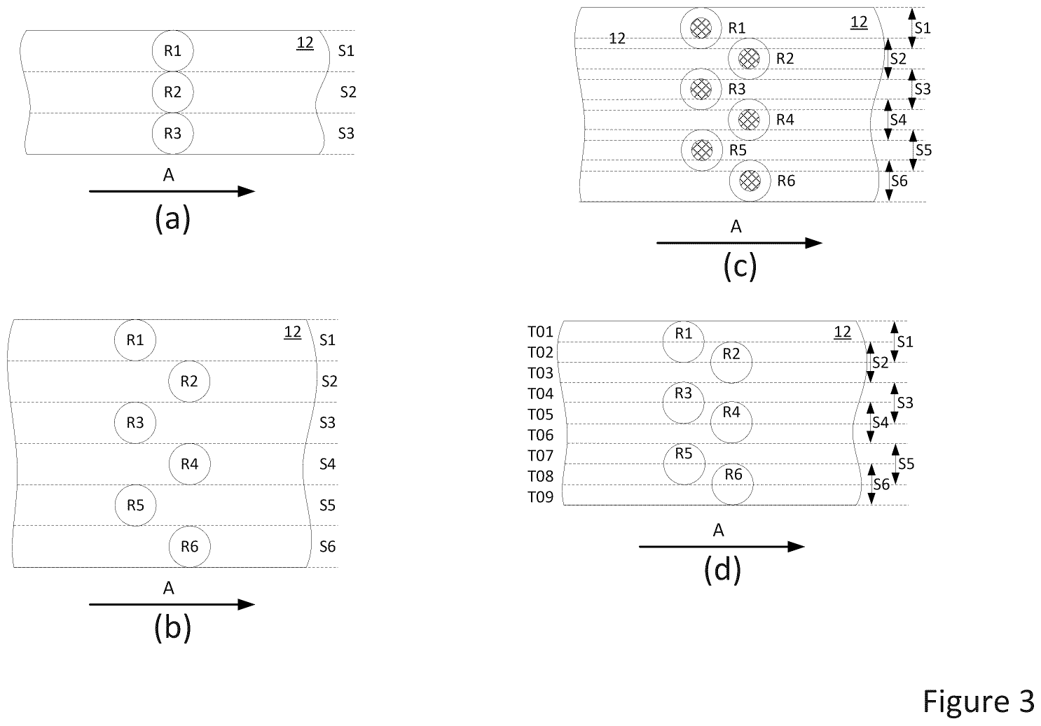

FIGS. 3 (a) to 3 (d) each shows a different pattern of localised coverage areas provided by a particular arrangement of reader antennas that may be used in the system of FIG. 1;

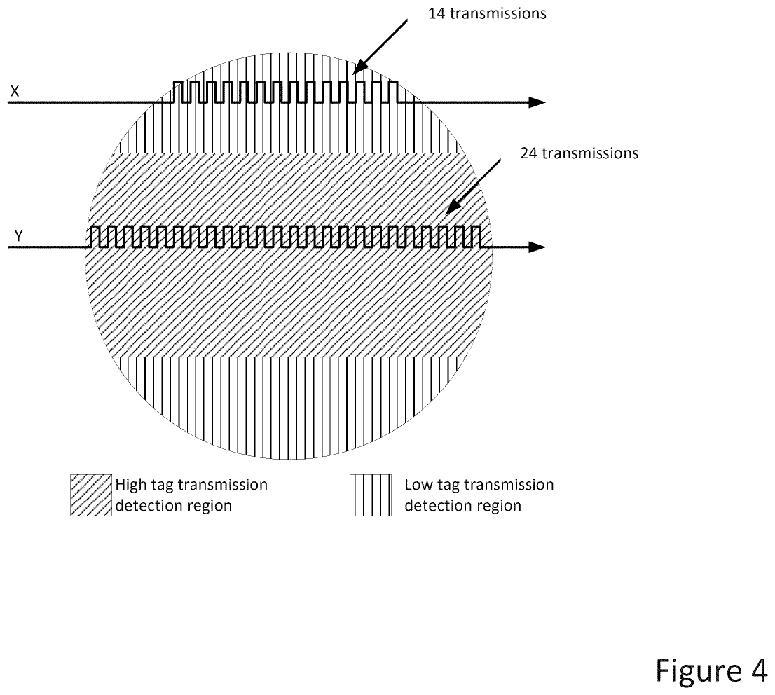

FIG. 4 is a simplified illustration of transmissions by a tag passing through different parts of a localised coverage area in the system of FIG. 1;

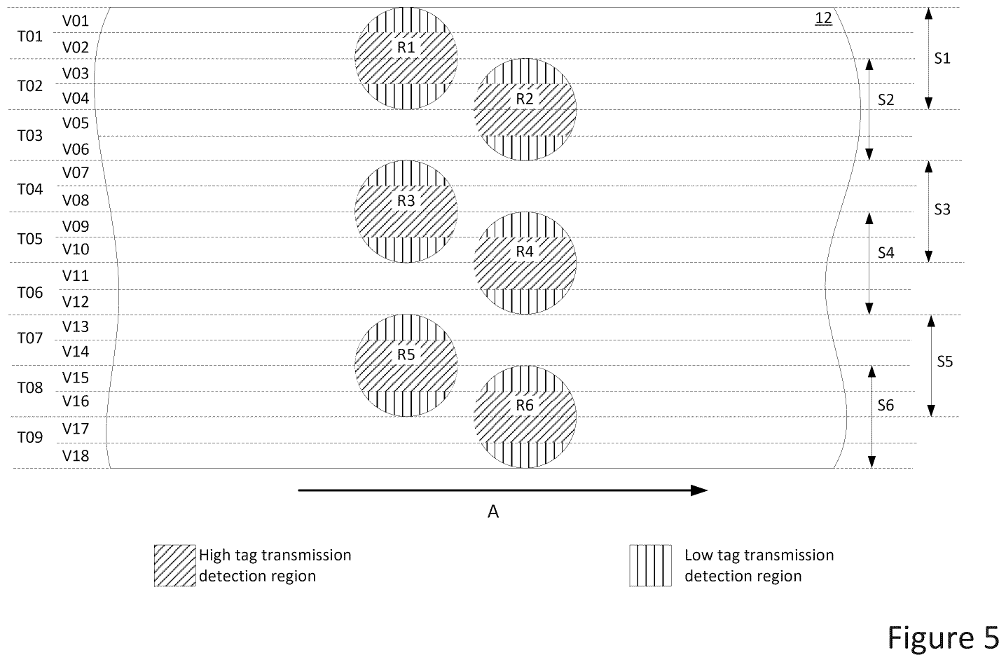

FIG. 5 illustrates an idealised example of how additional resolution may be achieved, for a given arrangement of reader antennas, in the system of FIG. 1;

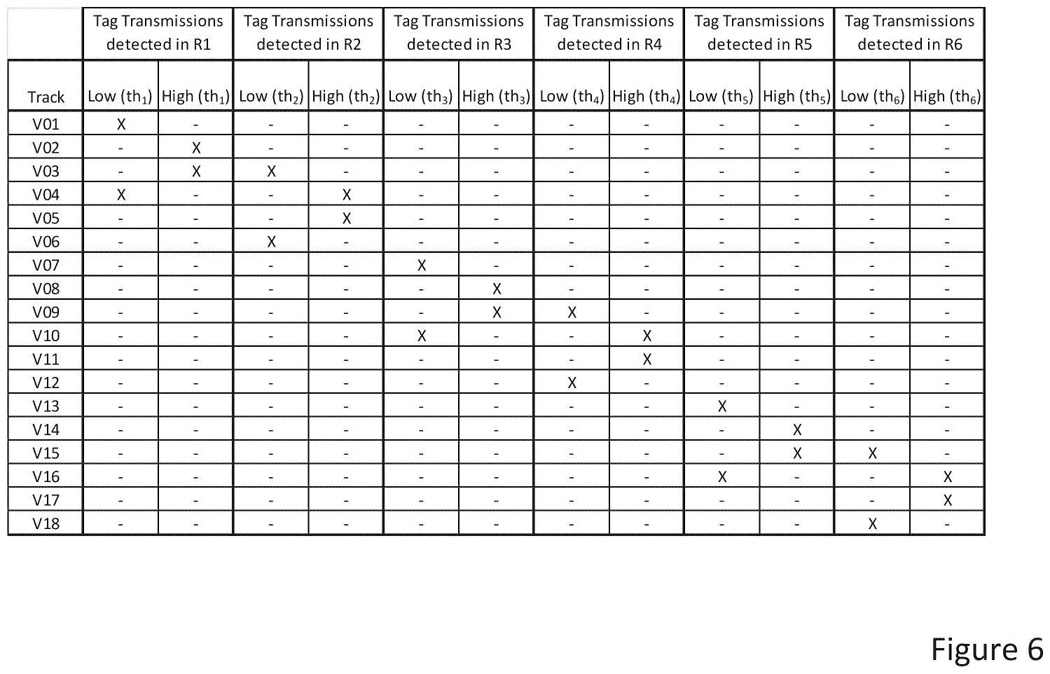

FIG. 6 is an exemplary decision matrix for the example illustrated in FIG. 5;

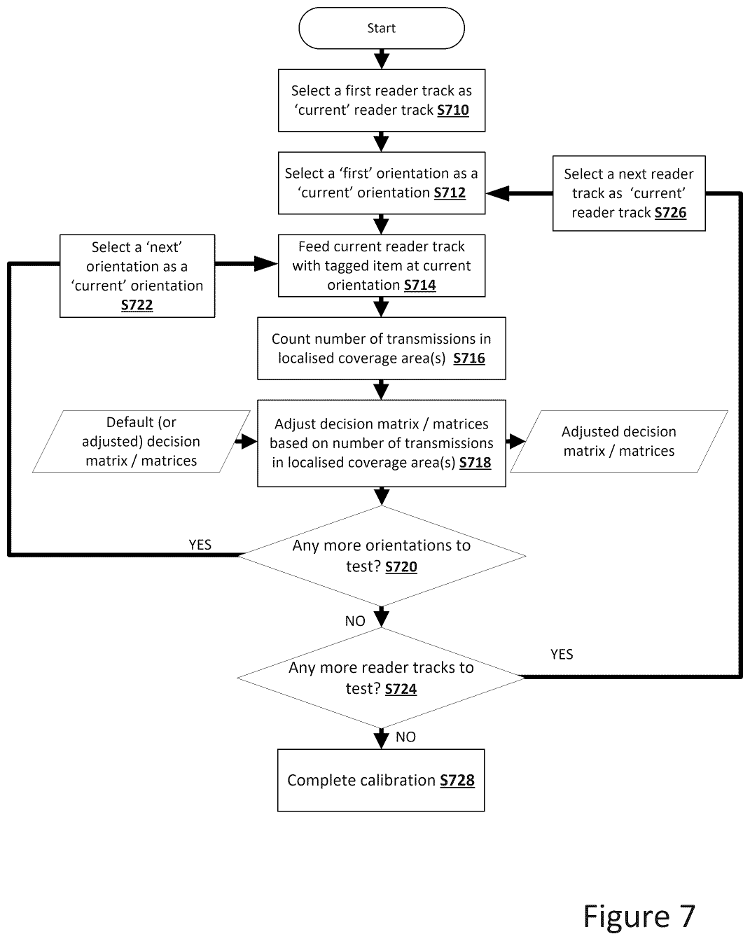

FIG. 7 illustrates a calibration procedure that may be used in the system of FIG. 1;

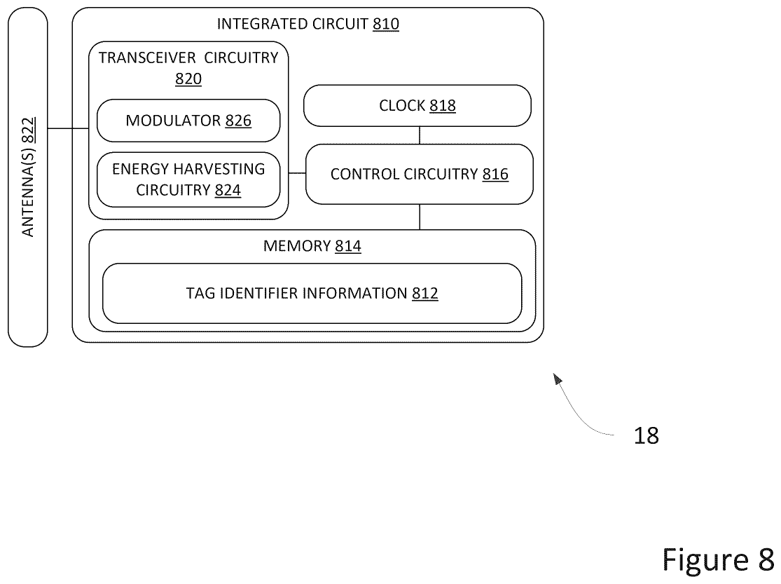

FIG. 8 is a simplified block schematic of a tag 18 that may be used in the system of FIG. 1; and

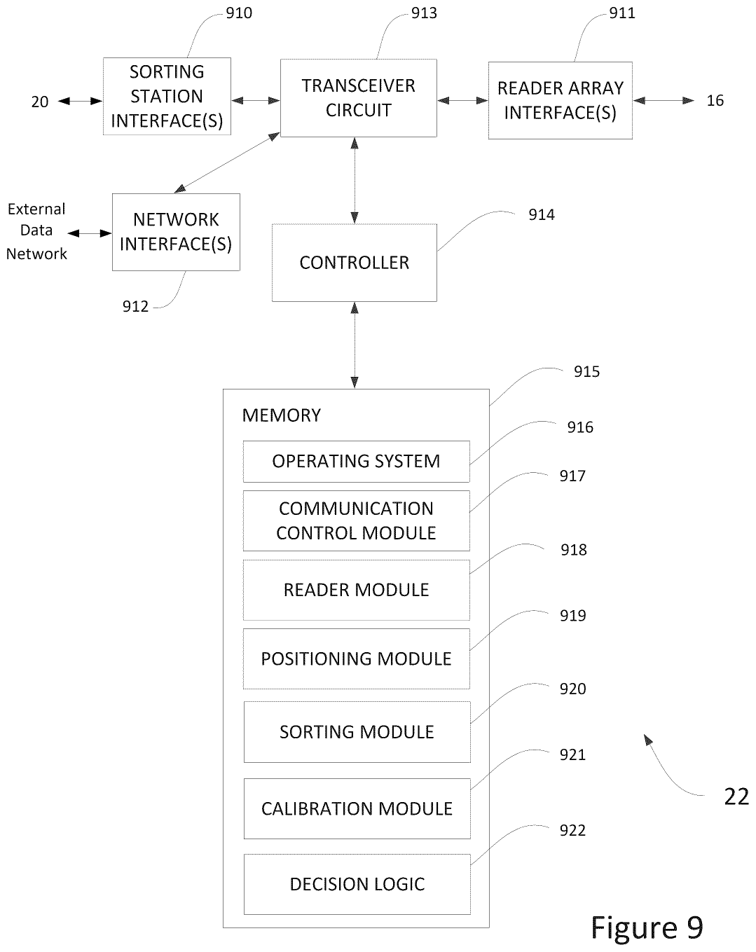

FIG. 9 is a simplified block schematic of control apparatus 22 that may be used in the system of FIG. 1.

### OVERVIEW

A system incorporating the invention will now be described in general overview, by way of example only, with reference to FIG. 1 and FIG. 2.

FIG. 1 is a simplified illustration of a system for separating objects, shown generally at 10. The system 10 comprises: a conveyor 12 for transporting objects 14 to be sorted in the direction indicated by arrow A; a reader array or ‘cluster’ 16 for reading tags 18 attached to the objects 14; a sorting station 20 for sorting objects 14 based on information read from the tags 18 by the reader array 16; and control apparatus 22 for controlling the sorting station 20 based on the information read from the tags 18.

In the described examples, the objects 18 comprise items of waste packaging and the system 10 is a system for sorting the waste packaging for the purposes of efficient recycling. In such systems it is advantageous to be able to accurately identify, and determine a position of, each object quickly and efficiently in order to maximise the throughput and hence capacity of the system.

Each tag 18 attached to a respective object 14 being transported by the conveyor comprises, in the described examples, a passive, Radio Frequency Identification (RFID), tags talk only (TTO), tag or the like. It will be appreciated that while a passive RFID TTO tag is described by way of example, the tags 18 could comprise any suitable form of RFID, or other type, of machine-readable tag. It is also possible that different types of tag 18 might be used on different objects or even the same object.

The reader array 16 is arranged for reading the tags 18 attached to the objects 14 being transported by the conveyor. Accordingly, the reader array 16, in the described examples, is configured for reading passive RFID TTO tags 18. It will, nevertheless, be understood that the reader array 16 could, alternatively or additionally, be configured to read other types of tag 18 also, depending on requirements.

As seen in FIG. 1, in this example, the reader array 16 comprises an array of reader antennas that are arranged with respect to the conveyor 12 to illuminate the entire, or at least a major part of, the transverse width of the conveyor 12 with RF radiation. The reader antennas are arranged to provide a combined coverage area 26 through which every object 14 on the conveyor 12 will pass through as it is transported towards the sorting station 20. This allows information (for example a tag identifier that is associated with the type of object to which it is attached) that is stored in the respective tag 18 of each object 14 to be read successfully.

The control apparatus 22 controls the reader antennas of the reader array 16 to read the information that is stored in the respective tag 18 of each object 14 (e.g., an item specific identifier or code). The control apparatus 22 then discriminates between different objects 14 based on the information that is read via the reader antennas and received at the control apparatus 22. The control apparatus 22 also determines a respective location of each object on the conveyer 12 based on the information obtained via the reader antennas of the reader array 16. The control apparatus 22 controls the sorting station 20 to separate each object 14 appropriately based on the respective location determined for that object 14 and the information read from that object 14.

In the described example, the control apparatus 22 is therefore configured to provide the reader functionality for reading the information carried by the signals received via the antennas. It will be appreciated, however, that each reader antenna may form part of a respective local reader, having its own reader circuitry and logic, that provides information read from the received signals to the control apparatus 22.

The sorting station 20 is shown, for illustrative purposes only, as being a relatively sophisticated sorting station with a robotic arm that picks up objects 14 and sorts them into associated bins or the like, based on feed back from the reader array 16, under the control of the control apparatus 22. It will, nevertheless, be appreciated that the sorting station 20 may be any suitable type of sorting station, for example an air-jet sorting station.

Beneficially, as will be described in more detail later, the arrangement of the reader antennas in the reader array 16 is designed to simplify and streamline the determination of a respective location of each object passing through the combined coverage area 26. Specifically, each reader antenna is arranged to provide a respective localised coverage area, that forms part of the combined coverage area 26, at a known location relative to the conveyor 12. This allows the transverse location of each object 14 with respect to the conveyor 12 to be determined, by the control apparatus 22, based on which reader antenna (or antennas) has (or have) detected and read the tag 18 of that object 14 (in combination with information corresponding to a transverse location of the part of the combined coverage area 26 provided by the corresponding reader antenna(s)).

Similarly, a relative longitudinal location of each object 14 (e.g., with respect to the sorting station 20) may be determined (and tracked as the conveyor 12 moves), by the control apparatus 22. This determination may, for example, be based on which reader antenna (or antennas) has (or have) detected and read the tag 18 of that object 14, and a time at which the tag 18 is detected. This information may be used, for example, in combination with information corresponding to a longitudinal location of the part of the combined coverage area 26 provided by the corresponding reader antenna(s), and information representing the speed at which the objects 14 are moving. It will be appreciated that while the relative longitudinal location may be represented spatially (e.g., as a distance from the sorting station 20 or some other fixed point), the relative longitudinal location may additionally, or alternatively, be represented temporally (e.g., as a time period before the object reaches the sorting station 20 or some fixed point).

One possible beneficial arrangement of reader antennas in the reader array 16 will now be described, by way of example only, with specific reference to FIG. 2 which is a simplified illustration of one possible exemplary arrangement for a reader array 16 that may be used in the system 10 of FIG. 1.

As seen in FIG. 2, the reader array 16 comprises two banks 16-1, 16-2 of reader antennas 30-1 to 30-6. Each reader antenna 30-1 to 30-6 is arranged to illuminate a respective portion of the conveyor 12 with RF radiation to provide a corresponding localised coverage area R1 to R6 (forming part of the wider combined coverage area 26 that extends the full transverse width of the conveyor 12). As seen in FIG. 2, each localised coverage area, R1 to R6, is shown, for illustrative purposes, as being circular and having an inner portion (cross-hatched) and an outer portion (without hatching). In reality the shape of the coverage area may deviate from being circular depending, for example, on the antenna arrangement, any electronic beam steering applied, and/or other, implementation specific, factors.

The two banks 16-1, 16-2 are separated in the longitudinal direction relative to the conveyor 12 to form a first (or ‘upstream’) bank 16-1 that is located further towards an upstream end of the conveyer 12 than a second (or ‘downstream’) bank 16-2. The two banks 16-1, 16-2 are separated by a distance that is sufficient to avoid interference and/or coupling between the respective reader antennas 30-1 to 30-6 of each bank 16-1, 16-2. Similarly, the respective reader antennas 30-1 to 30-6 of each bank 16-1, 16-2 are separated in the transverse direction, relative to the conveyor 12, by a distance that is sufficient to avoid interference and/or coupling between those reader antennas 30-1 to 30-6.

In the arrangement shown in FIG. 2, the reader antennas 30-1, 30-3, 30-5 of the upstream bank 16-1, and the reader antennas 30-2, 30-4, 30-6 of the downstream bank 16-2, are mutually arranged in a manner that ensures that the entire width of the conveyor 12, through which objects 14 may pass, is covered by at least one (and sometimes two) localised coverage areas R1 to R6. The reader antennas 30-1 to 30-6 are mutually arranged to provide an arrangement of localised coverage areas R1 to R6 in which each localised coverage area R1, R3 and R5 of the upstream bank is: separated from one another; and is separated from, but aligns partially with, at least one coverage area R2, R4 and R6 of the downstream bank 16-2 in the longitudinal direction relative to the conveyor 12.

Specifically, the reader antennas 30-1 to 30-6 shown in FIG. 2 are arranged to provide a pattern of localised coverage areas R1 to R6 in which the inner portions of the localised coverage areas R1, R3, R5 provided by the upstream bank 16-1 are not aligned, in the longitudinal direction relative to the conveyor 12, with any portion of the localised coverage areas R2, R4, R6 provided by the downstream bank 16-2. Contrastingly, at least part of the outer portion of each localised coverage area R1, R3, R5 provided by the upstream bank 16-1 is aligned, in the longitudinal direction relative to the conveyor 12, with at least part of a respective outer portion of at least one localised coverage area R2, R4, R6 provided by the downstream bank 16-2.

In more detail, respective reader antennas 30-1 to 30-6 of each bank 16-1, 16-2 are arranged at a distance that results in a separation between adjacent localised coverage areas R1 to R6 (transversely with respect to the conveyor 12), being less than the transverse width (e.g., the diameter) of each coverage area R1 to R6. The reader antennas 30-1, 30-3, 30-5 of the upstream bank 16-1 are offset relative to the reader antennas 30-2, 30-4, 30-6 of the downstream bank 16-2 (in the transverse direction relative to the conveyor 12) in a manner that ensures that the entire width of the conveyor 12, through which objects 14 may pass, is covered by at least one (and sometimes two) localised coverage areas R1 to R6.

In the exemplary arrangement shown in FIG. 2, the reader antennas 30-1, 30-3, and 30-5 of one bank 16-1 are arranged, relative to the reader antennas 30-2, 30-4, and 30-6 of the other bank 16-2, with an offset that results in a respective centre of each localised coverage area R1, R3 and R5 provided by the upstream bank 16-1 being substantially aligned (in the longitudinal direction relative to the conveyor 12) with a centre of the gap between two localised coverage areas R2, R4, R6 provided by the downstream bank 16-2.

Accordingly in operation, as a result of this offset but partially aligned arrangement of localised coverage areas of one bank 16-1 with respect to those of the other bank 16-2, when the tagged objects 14 are travelling on the conveyer 12 the corresponding tag 18 will be read by one, or possibly two, reader antennas 30-1 to 30-6. It can be seen that the specific reader antenna 30-1 to 30-6, or combination of reader antennas 30-1 to 30-6, that reads a particular tag 18 is indicative of the transverse position of the tag 18, and hence of the object 14 to which it is affixed. Similarly, the timing at which each reader antenna 30-1 to 30-6 starts/finishes detecting a tag 18 is indicative of the longitudinal position of that tag 18, and hence of the object 14 to which it is affixed.

In effect, the antenna arrangement, divides the conveyor 12 into a set of overlapping longitudinal zones or antenna ‘streams’ S1 to S6, where each zone or antenna stream S1 to S6 represents a corresponding part of the conveyor 12 that passes through a respective localised coverage area R1 to R6. By overlapping the streams S1 to S6 in a transverse direction, the arrangement effectively divides the conveyor into multiple narrower ‘overlap-based’ streams or ‘sub-streams’ (which may also be referred to as reader channels or tracks). Hence, a greater degree of spatial resolution or ‘granularity’ is provided in relation to the position of tagged items 14 (transversely with respect to the conveyor 12) because a relative position of an item within each stream can be ascertained (e.g., as one of three relative positions—‘top’, ‘middle’, or ‘bottom’—in the case of localised coverage areas 30-2 to 30-5).

For example, a first tagged item 14 positioned, near the middle of stream S1 that passes through the localised coverage area R1 of antenna 30-1, will pass through only the inner portion (cross-hatched area) of that localised coverage area R1. Contrastingly, a second tagged item 14 positioned in the part of stream S1 that passes through the outer portion (without cross-hatching) of the localised coverage area R1 that is furthest from the far edge (i.e., closest to the middle) of the conveyor 12 (as viewed in FIG. 2) will also pass through the outer portion of the localised coverage area R2 that is closest to the far edge (i.e., furthest from the middle) of the conveyor 12 (as viewed in FIG. 2). The first item will therefore only be detected by antenna 30-1, whereas the second item will be detected by both antenna 30-1 and 30-2. Accordingly, the control apparatus 22 can determine the position of the first item to be within a reader track corresponding to the non-overlapping part of stream S1 and the position of the second item to be within a reader track corresponding to the part of stream S1 that overlaps with the stream S2.

The control apparatus 22 can thus use the information received from the different antennas 30-1 to 30-6 to determine which antenna, or plurality of antennas, have detected the tag 18 of a given object 14 to determine a transverse position of that object 14 relative to the conveyor with a reasonable degree of spatial resolution.

### Antenna Arrangements/Coverage Patterns

It will be appreciated that whilst a particular arrangement of reader antennas has been described, that provides a pattern of localised coverage areas having specific benefits, other arrangements of reader antennas are possible which provide different benefits. A few arrangements of reader antennas, that may be used in the system of FIG. 1, will now be described, by way of example only, with reference to FIGS. 3 (a) to 3 (d), each of which shows a different pattern of localised coverage areas provided by a particular arrangement of antennas.

FIG. 3 (a) shows a particularly simple pattern of localised coverage areas R1 to R3 that may be provided by a single bank of adjacent reader antennas. In this example, there are three reader antennas arranged to provide three corresponding adjacent localised coverage areas R1 to R3 (and hence three associated antenna streams S1 to S3) that extend across the width of the conveyor 12.

In this example the streams S1 to S3 do not overlap and so the conveyor 12 may be physically divided into channels corresponding to each stream thereby allowing a relatively simple sorting mechanism to be used. Specifically, the conveyor 12 may be provided with physical separators that divide the conveyor into separate channels, with a different respective channel corresponding to each antenna stream S1 to S3, to ensure that each item passes through only one antenna's RF field, so that its position can be determined as being in the related stream S1 to S3.

However, whilst this arrangement has some benefit in terms of simplicity, and the ability to use a minimum number of reader antenna to cover the width of the conveyor, the proximity of the reader antennas to one another has the potential to cause coupling between adjacent antennas (and/or overlapping RF fields). Where the reader antennas are sufficiently separated to avoid such coupling and/or overlap there is the potential for ‘blind spots’ where tagged items may not be detected.

FIG. 3 (b) shows another pattern of localised coverage areas R1 to R6 that may be provided by two banks of receiver antennas. In this example, there are six reader antennas (three in each bank) arranged to provide six corresponding adjacent localised coverage areas R1 to R6 (and hence six associated antenna streams S1 to S6) that extend across the width of the conveyor 12.

Like the example discussed with reference to FIG. 2, in the example of FIG. 3 (b) the two banks are separated in the longitudinal direction relative to the conveyor 12 to form an upstream bank that is located further towards an upstream end of the conveyer 12 than a downstream bank. The two banks are separated by a distance that is sufficient to avoid interference and/or coupling between the respective reader antennas of each bank. Similarly, the respective reader antennas of each bank are separated in the transverse direction, relative to the conveyor 12, by a distance that is sufficient to avoid interference and/or coupling between those reader antennas.

In the arrangement shown in FIG. 3 (b), the reader antennas of the upstream bank, and the reader antennas of the downstream bank, are offset from one another in an arrangement that ensures that the entire width of the conveyor 12, through which objects may pass, is covered. Unlike the example discussed with reference to FIG. 2, however, the reader antennas are mutually arranged to provide a pattern of localised coverage areas R1 to R6 in which the antenna streams corresponding to the localised coverage areas R1, R3 and R5 of the upstream bank do not overlap significantly with the localised coverage areas R2, R4 and R6 of the downstream bank.

Like the example discussed with reference to FIG. 3 (a), therefore, the antennas of this example are arranged such that the streams S1 to S6 corresponding to the localised coverage areas do not overlap significantly. Hence, the conveyor 12 may be provided with physical separators that divide the conveyor into separate channels, with a different respective channel corresponding to each antenna stream S1 to S6, to ensure that each item passes through only one antenna's RF field, so that its position can be determined as being in the related stream S1 to S6.

This arrangement has some benefit in terms of avoiding the risk of mutual antenna coupling associated with the example of FIG. 3 (a), and relative simplicity (albeit slightly more complex than the example of FIG. 3 (a)). This arrangement also allows the use of a minimum number of reader antennas to cover the width of the conveyor.

FIG. 3 (c) shows another pattern of localised coverage areas R1 to R6 that may be provided by two banks of receiver antennas. This example corresponds essentially to the example described with reference to FIG. 2 and so will not be described again in detail.

As described with reference to FIG. 2, in the example of FIG. 3 (c) the two banks are separated in the longitudinal direction relative to the conveyor 12 to form an upstream bank that is located further towards an upstream end of the conveyer 12 than a downstream bank. The two banks are separated by a distance that is sufficient to avoid interference and/or coupling between the respective reader antennas of each bank. Similarly, the respective reader antennas of each bank are separated in the transverse direction, relative to the conveyor 12, by a distance that is sufficient to avoid interference and/or coupling between those reader antennas.

In the arrangement shown in FIG. 3 (c), the reader antennas of the upstream bank, and the reader antennas of the downstream bank, are offset from one another in an arrangement that ensures that the entire width of the conveyor 12, through which objects may pass, is covered by localised coverage areas R1 to R6. Unlike the example discussed with reference to FIG. 3 (b), the reader antennas are mutually arranged to provide a pattern of localised coverage areas R1 to R6 in which the antenna streams S1, S3, S5 corresponding to the localised coverage areas R1, R3 and R5 of the upstream bank overlap with the antenna streams S2, S4, S6 corresponding to localised coverage areas R2, R4 and R6 of the downstream bank in a longitudinal direction relative to the conveyor 12.

Specifically, inner portions of the localised coverage areas R1, R3, R5 provided by the upstream bank 16-1 are not aligned with any portion of the localised coverage areas R2, R4, R6 provided by the downstream bank. At least part of the outer portion of each localised coverage area R1, R3, R5 provided by the upstream bank is, however, aligned in a transverse direction with at least part of a respective outer portion of at least one localised coverage area R2, R4, R6 provided by the downstream bank.

This arrangement has benefit in terms of avoiding the risk of mutual antenna coupling associated with the example of FIG. 3 (a) and, as discussed above, provides additional positioning resolution compared to the examples of FIGS. 3 (a) and 3 (b), albeit at the expense of some additional complexity and the possible need for more antennas and/or larger antennas for a given width of conveyor 12. The additional spatial resolution provided by the narrower overlap-based reader tracks formed by the overlapping streams is not, however, completely uniform across the conveyor with the reader tracks formed at the edges of the conveyor being wider than those in the middle. It will be appreciated that while, in the illustrated example, the reader tracks corresponding to the outer portions of the localised coverage areas is narrower than those corresponding to the centre of the localised coverage areas, these could be made substantially the same width by adjusting the relative offset between the antennas of each bank and the transverse separation between the antennas.

FIG. 3 (d) shows another pattern of localised coverage areas R1 to R6 that may be provided by two banks of receiver antennas. This example has some similarity with the example described with reference to FIGS. 2 and 3 (c). For example, the localised coverage areas R1 to R6 in FIG. 3 (d) are provided by a reader array, comprising an upstream bank of receiver antennas and a downstream bank of receiver antennas, in which the reader antennas of the upstream bank, and the reader antennas of the downstream bank, are offset in a transverse direction from one another in an arrangement that ensures that the entire operational width of the conveyor 12 is covered.

Moreover, as with the example of FIGS. 2 and 3 (c), the two banks are separated by a longitudinal distance that is sufficient to avoid interference and/or coupling between the respective reader antennas of each bank. Similarly, the respective reader antennas of each bank are separated in the transverse direction, relative to the conveyor 12, by a distance that is sufficient to avoid interference and/or coupling between those reader antennas.

However, unlike the example of FIGS. 2 and 3 (c), there is a degree of asymmetry in the placement of the downstream bank of antennas with respect to those of the upstream bank. Effectively, the antennas providing localised coverage areas R2, R4 and R6 are shifted ‘upwards’ (as viewed in FIG. 3 (d)) compared to FIG. 3 (c) so that the antenna stream S1 to S6 corresponding to each localised coverage area R1 to R6 of one bank overlaps with only one antenna stream S1 to S6 corresponding to one of the localised coverage areas R1 to R6 of the other bank.

In more detail, the respective antennas of each bank are arranged to provide localised coverage areas in which approximately half of each coverage area R1, R3 and R5 provided by the upstream bank of reader antennas (e.g., the ‘lower’ half as viewed in FIG. 3 (d)) is aligned, in a longitudinal direction relative to the conveyor 12, with approximately half of each coverage area R2, R4 and R6 provided by the downstream bank of reader antennas (e.g., the ‘upper’ half as viewed in FIG. 3 (d)).

More specifically, the transverse offset between the coverage areas R1, R3 and R5 provided by the upstream bank of reader antennas and the coverage areas R2, R4 and R6 provided by the downstream bank of reader antennas is substantially equal to half the transverse width (i.e., half the diameter in the case of a circular coverage areas) of the coverage areas.

Accordingly, the antennas of this example are arranged such that approximately half of each antenna stream S1, S3 and S5, corresponding to a respective upstream localised coverage area R1, R3 and R5, overlaps with approximately half of one of the antenna streams S2, S4 and S6 corresponding to the downstream localised coverage areas R2, R4 and R6. In the example shown in FIG. 3 (d) this results in nine separate narrower overlap-based reader tracks T01 to T09, of essentially equal width, within which objects being transported via the conveyor 12 may be localised.

For example, with this asymmetric arrangement: a tagged item positioned in sub-stream T01 will pass through only localised coverage area R1; a tagged item positioned in sub-stream T02 will pass through both localised coverage areas R1 and R2; a tagged item positioned in sub-stream T03 will pass through only localised coverage area R2; and so on.

For all of these antenna arrangements the response of the antenna array to a distribution of items on the conveyor may be optimised by adjustment of the area of each antenna field and/or the number of antennas in a row across the lateral width of the conveyor 12. For the arrangements in which individual antenna streams overlap the response of the antenna array to a distribution of items on the conveyor may be further optimised based by adjusting: the number of banks of antennas; the separation of the antennas and/or the separation of fields generated by the antennas laterally and/or longitudinally relative to the conveyor 12; and/or the extent of any overlap between the antenna streams (i.e., the extent to which any part of a localised coverage area in one bank aligns, in a longitudinal direction, with a corresponding part of a localised coverage area of another bank). It can be seen, therefore, that depending on requirements any suitable number of antennas, antenna separations, and banks of antennas may be used to provide an appropriate optimisation between lateral positioning resolution and system complexity.

Moreover, whilst all of the arrangements shown employ a uniform distribution of antennas arranged to provide a uniform distribution of localised coverage areas of similar size, there may be applications in which a non-uniform distribution may be beneficial. For example, if the objects being sorted tend to be distributed across the conveyor in an approximate size order (e.g., with bigger objects tending to be at one edge, both edges, or the centre) then it may be advantageous to arrange the antennas to have smaller streams (or sub-streams) covering the part(s) of the conveyor 12 where smaller objects are expected.

### Additional Spatial Resolution

While the antenna arrangements described above can be configured to provide additional lateral spatial resolution by appropriate placement of reader antennas, additional lateral positioning spatial resolution can also be achieved, in any of the above arrangements, by making beneficial use of an appropriate RFID protocol. For example, a protocol in which multiple transmissions will be detected from a given tag, as that tag passes through each localised coverage area and is therefore powered by the RF radiation from the corresponding antenna, can be used to provide additional spatial resolution based on the number of transmissions detected during passage of a tagged item through a localised coverage area.

Specifically, if an RFID protocol used in which each tag, when powered up by a reader antenna, provides a regularly repeating pattern (which encodes a unique identifier associated with the tag), then the repetition period, conveyor speed, and the longitudinal distance that a given tag has to travel, as it traverses the localised coverage area, will determine the typical number of detections for that tag. Thus, the number of times that the repeating pattern is read, as a tag traverses a localised coverage area, provides a measure of the distance that it travelled through the RF field. This distance will be greater near the centre of the localised coverage area than at the edge and so the number of detections is indicative of the part of the coverage area that a detected item passes through.

This is shown, by way of example only, in FIG. 4 which is a simplified illustration of transmissions by a tag passing through different parts of a localised coverage area. In FIG. 4, arrow X illustrates transmission during passage of a tag through an edge portion of the localised coverage area and arrow Y illustrates transmission during passage of a tag through a centre portion of the localised coverage area. The transmissions of the tag in each case are represented by a square wave type pattern in which each peak represents a respective tag transmission of the repeating pattern and the spaces between the peaks represent delay periods between transmissions of the repeating pattern.

A tag in the position represented by arrow X will therefore make 14 transmissions during its transit of the reader antenna's RF field. In contrast, a tag in the position represented by arrow Y will make 24 transmissions during its transit. Hence the number of transmissions detected, via a reader antenna, from a particular tag indicates the position of that tag in that reader antenna's RF field.

This can be combined with the overlapping antenna streams described above to provide even greater spatial resolution. For example, FIG. 5 illustrates (in idealised form) how additional spatial resolution may be achieved for one such arrangement in which the antennas are arranged to provide a pattern of localised coverage areas similar to that shown in FIG. 3 (d).

As seen in FIG. 5, each overlapping portion, and each non-overlapping portion, of the antenna streams S1 to S6 (i.e., corresponding to the narrower overlap-based reader tracks T01 to T09 also shown in FIG. 3 (d)) respectively has a first (‘high tag transmission’) part that passes through a centre portion of the corresponding localised coverage area R1 to R6, and a second (‘low tag transmission’) part that passes through one of the edge portions of the corresponding localised coverage area R1 to R6.

Effectively, therefore, each of the overlap-based reader tracks T01 to T09 can be considered to comprise a plurality of (in this example two) even narrower ‘transmission-occurrence’ based streams or ‘sub-streams’ (also referred to as reader channels or tracks) V01 to V18 depending on the number of times a transmission from a given tag is detected as it traverses the corresponding localised coverage area. In order to provide additional spatial resolution in this example, therefore, the control apparatus 22 distinguishes between different longitudinal parts of each overlap-based reader track T01 to T09 based on a respective comparison of the number of transmissions exhibited by a tag, of a tagged item, with one or more threshold values as that tagged item traverses the corresponding localised coverage area(s) R1 to R6.

For example, tagged items within the overlap-based reader track T01 that exhibit a higher number of transmissions (i.e., exceeding a corresponding threshold), during passage through localised coverage area R1, are considered to be in the lower part of that overlap-based reader track T01 (as viewed in FIG. 5). Such tagged items are thus determined to be within the corresponding transmission-occurrence based reader track V02. Similarly, tagged items within the overlap-based reader track T01 that exhibit a lower number of transmissions (i.e., not exceeding a corresponding threshold), during passage through localised coverage area R1, are considered to be in the upper part of that overlap-based reader track T01 (as viewed in FIG. 5). Such tagged items are thus determined to be within the corresponding transmission-occurrence based reader track V01.

In another example, tagged items within the overlap-based reader track T02 that:
exhibit a higher number of transmissions (i.e., exceeding a corresponding threshold) during passage through localised coverage area R1; and
exhibit a lower number of transmissions (i.e., not exceeding a corresponding threshold) during passage through localised coverage area R2;
   are considered to be in the upper part of that overlap-based reader track T02 (as viewed in FIG. 5). Such tagged items are thus determined to be within the corresponding transmission-occurrence based reader track V03.

Similarly, tagged items within the overlap-based reader track T02 that:
exhibit a lower number of transmissions (i.e., not exceeding a corresponding threshold) during passage through localised coverage area R1; and
exhibit a higher number of transmissions (i.e., exceeding a corresponding threshold) during passage through localised coverage area R2;
   are considered to be in the lower part of that overlap-based reader track T02 (as viewed in FIG. 5). Such tagged items are thus determined to be within the corresponding transmission-occurrence based reader track V04.

It can be seen, therefore, that the number of transmissions detected by the reader from a particular tag indicates its lateral position, with respect to the conveyor, in each reader antenna's RF field. By combining this with the overlap-based reading tracks even greater spatial resolution can be achieved. In the arrangement shown in FIG. 5, for example, this allows tagged items to be localised to a lateral position accuracy of approximately one quarter of the lateral width (diameter) of an antenna's localised coverage area.

It will be appreciated that further spatial resolution can potentially be achieved by introducing additional thresholds to effectively divide the localised coverage area into a greater number of smaller lateral regions where sufficient precision could be achieved in counting the different number of transmissions. For example, thresholds could potentially be defined to delineate the number of transmissions expected from a tagged item passing through: a central third of the localised coverage area (in a lateral direction); one of the two outermost sixths of the localised coverage area (in a lateral direction); and one of the two remaining sixths between the central third and an outermost sixth).

It will also be appreciated that whilst the same thresholds may be used for each localised coverage area, different localised coverage area/antenna specific thresholds may be defined, for example to calibrate for local antenna-to-antenna variations causing differences in their associated localised coverage areas. Moreover, rather than only using a single threshold for determining whether a given transmission count is ‘high’ or ‘low’, based on a comparison of that transmission count with that single threshold, each transmission count could be compared to one or more ranges of possible transmission count values. For example, a range of values may be defined within which any valid transmission count is expected to fall (e.g., by defining a minimum expected value and/or a maximum expected value). If the transmission count is below a minimum value (or above any maximum value) it may be considered to be out-of-range and hence invalid. Similarly, one range could be defined within which a transmission count is considered to be high, and another range could be defined within which a transmission count is considered to be low.

It will be also appreciated that whilst the additional spatial resolution based on the number of detections is particularly beneficial for patterns, such as those shown in FIGS. 3 (c) and 3 (d) in which the antenna streams overlap, the principles described can be applied for any of the other patterns of localised coverage areas. Any ambiguity between the two outer edges (e.g., between V01 and V04 for localised coverage area R1 in FIG. 5) of a given antenna stream can potentially be resolved, if needed, in another way. For example, ambiguity could potentially be addressed by using different shaped (e.g., elliptical) localised coverage areas arranged at an angle to the longitudinal axis of the conveyor in combination with the timing at which an item is detected (for example, relative to a reference time at which a tagged item/tag is detected by another sensor before, during, or after transit of the localised coverage are). It will be appreciated that use of a number of readers providing diagonally arranged coverage areas covering the same track area may also be beneficial in improving positioning accuracy with respect to tags positioned at various non-parallel orientations to the conveyor. Tags positioned at angles to the conveyor can skew the assumed position significantly (e.g., by up to 50% of the read range at) 45°. Thus, having knowledge of a tag field of view and angle for readers placed at different angles to the conveyor has the potential to mitigate such issues.

### Decision Matrices

Any suitable method may be used for determining, based on the detected transmissions from tagged items, which antenna stream S1 to S6, overlap-based track T01 to T09, and/or transmission-occurrence based track V01 to V09 a tagged item is within.

In one particularly beneficial method that can be implemented in the system of FIG. 1, the control apparatus 22 uses of one or more decision matrices to decide the location of a detected tagged item.

One such decision matrix will now be described, by way of example only, with reference to FIG. 6, which is an exemplary decision matrix for the combined transmission-occurrence and overlap-based example illustrated in FIG. 5.

Referring to FIG. 6, when a tagged item is detected within a particular localised coverage area R1 to R6 the number of transmissions detected for that tagged item are respectively counted for each localised coverage area through which the tagged item passes. The count for each localised coverage area R1 to R6 is then compared to a respective antenna specific threshold (th₁ to th₆), or a common threshold, to determine whether the number of transmissions is ‘high’ (i.e., greater than—or no less than—the threshold) or ‘low’ (i.e., less than—or no greater than—the threshold). The results of this determination are then used, together with the decision matrix, to identify which occurrence-based reader track the results correspond to (or correspond best to).

Specifically, in the illustration of the decision matrix in FIG. 6, each ‘X’ in a given row and column indicates a respective condition (represented by that column's header) that is to be met for a tagged item to be identified as being in the corresponding occurrence-based reader track V01 to V18 (represented by the label at the start of that row).

For example, a detected tagged item that is detected in both localised coverage areas R5 and R6:
is determined to be within occurrence-based reader track V15 when the detected tag is determined to exhibit a high transmission count in localised coverage area R5 AND the detected tag is determined to exhibit a low transmission count in localised coverage area R6; and
is determined to be within occurrence-based reader track V16 when the detected tag is determined to exhibit a low transmission count in localised coverage area R5 AND the detected tag is determined to exhibit a high transmission count in localised coverage area R6.

Similarly, a detected tagged item that is detected in only localised coverage area R5:
is determined to be within occurrence-based reader track V13 when the detected tag is determined to exhibit a low transmission count in localised coverage area R5;
is determined to be within occurrence-based reader track V14 when the detected tag is determined to exhibit a high transmission count in localised coverage area R5.

Similarly, a detected tagged item that is detected in only localised coverage area R6:
is determined to be within occurrence-based reader track V17 when the detected tag is determined to exhibit a high transmission count in localised coverage area R6;
is determined to be within occurrence-based reader track V18 when the detected tag is determined to exhibit a low transmission count in localised coverage area R6.

It can be seen that similar logic applies to the other occurrence-based reader tracks V01 to V18 and, in the interests of brevity, will not be set out in detail.

### Compensation for Orientation Induced Variation

In real world implementations the effective shape and effective size of the localised coverage areas can vary depending on the orientation of the tag on a tagged item passing through that localised coverage area. Hence, the number of transmissions detected in a given reader track may vary within a range of values depending on orientation.

In one particularly beneficial method that can be implemented in the system of FIG. 1, orientation induced variation is compensated for in advance by means of a calibration procedure in which each reader track is systematically fed with tagged items at different orientations. The decision logic for identifying the reader track in which a tagged item is located is then adjusted, based on the respective numbers of transmissions actually detected for each different orientation in each reader track.

For example, the threshold(s) (or range(s)) on which a decision matrix, such as that shown in FIG. 6, may be adjusted to take account of the range of possible transmission numbers arising from such orientation differences.

FIG. 7 illustrates, by way of example, one of many possible calibration procedures that may be used in the system of FIG. 1. In the calibration procedure of FIG. 7 an initial reader track and initial orientation are first selected, at S710 and S712 respectively, as a current reader track and current orientation, before that current track is fed with a tagged item at the current orientation at S714. The number of transmissions exhibited in each localised coverage area (or at least the localised coverage area(s) corresponding to the current reader track) during transit of the tagged item is then counted at S716. The result(s) of each count are then used to adjust (or possibly generate), one or more initial (e.g., default) or previously adjusted decision matrices at S718. The procedure represented by S714 to S718 is respectively repeated iteratively for each orientation, of a set of orientations, being treated as the current orientation (at S722), until all orientations of the set of orientations are determined to have been tested (at S720). The procedure represented by S712 to S718 is then respectively repeated iteratively for each reader track being treated as the current reader track (at S726), until all reader tracks are determined to have been tested (at S724). Calibration then completes at S728. It will be appreciated that whilst a specific procedure is described for illustrative purposes there are many possible variations on the procedure. For example, instead of testing every orientation in a given reader track and then changing the reader track, every reader track could be tested for a given orientation before changing the orientation.

In a particularly beneficial variation of this, a set of decision matrices could be defined comprising a respective decision matrix for each of a plurality of different orientations. In operation, the control apparatus 22, could then choose a decision matrix to use, for a given tagged item, to be the decision matrix exhibiting the best fit to the transmission counts exhibited by that tagged item. This variation is particularly beneficial because, in addition to allowing a lateral position to be determined with a high level of precision and accuracy more reliably, it also allows for other possible beneficial features. For example, the control apparatus 22 may infer an orientation of a tagged item based on which of the set of decision matrices is found to fit best with the measured transmission counts, and to control the sorting station to take account of that inferred orientation.

In another beneficial variation of the calibration procedure, a set of decision matrices could be defined comprising a respective decision matrix for each of a plurality of different conveyor speeds (these speed specific decision matrices may be used instead of or in combination with orientation specific decision matrices). Accordingly, the transmission counts seen in operation may be compared against one or more decision matrices as appropriate to identify the reader track (and possibly tag orientation) based on knowledge of the reader antennas via which a tagged item was detected, the number of transmissions counted, and a known conveyor (‘line’) speed.

Additional benefit could also be achieved by using reader antennas oriented at different angles relative to an ‘unknown’ tag position either in an extended reader array with additional reader antennas (or banks of antennas) or in one of the antenna arrays described with reference to FIG. 2, or 3 (a) to 3 (d). Decision matrices comprising data for all these different orientations can then be used by the system to calculate the tag orientation and to provide additional accuracy in the estimated tag location.

Further benefits may also be achieved by incorporating signal amplitude and/or signal phase thresholds or ranges into the decision matrices, and by comparing, during operation, measurements of actual signal amplitude and/or signal phase with the corresponding thresholds or ranges to provide additional accuracy in the estimated tag location and/or orientation.

In another beneficial variation, reader antennas may be moved between reading operations. Specifically, in the approaches described above, the items are moving relative to a number of static reader banks. It will be appreciated that the reader banks may alternatively move relative to static items. For example, this approach may be used in a scanning process aiming to identify the position of certain ‘contaminating’ items within a group of items, without moving the group. The non-contaminated items can then be moved after decontamination.

### Tag

An exemplary tag 18 will now be described in more detail, by way of example only, with reference to FIG. 8, which is a simplified block schematic of a tag 18 that may be used in the system of FIG. 1.

The tag 18 in this example is a Radio Frequency Identification (RFID) integrated circuit for a passive, tags talk only (TTO), RFID tag or the like.

The RFID tag 18 comprises an integrated circuit 810 having a memory 814 in which an identifier 812 is stored, the identifier may be unique to the tag 810 or to a to an item or type of item (e.g., type of packaging) to which the tag 810 is to be affixed.

The integrated circuit 810 also comprises control circuitry 816 for controlling overall operation of the RFID tag 18, and a clock 818 for providing timing signals for coordinating operation of the control circuitry 816 and hence the various functions of the tag. In this example the memory 814 comprises a read only memory (ROM).

The integrated circuit 810 also comprises transceiver circuitry 820 for receiving radio frequency (RF) excitation signals from an associated RFID reader, via one or more external antennas 822 of the tag 18, and for transmitting information from the RFID tag 18 to the RFID reader via the antenna(s) 822 under the control of the control circuitry 816. The transceiver circuitry 820, in this example, comprises energy harvesting circuitry 824 for harvesting energy from received excitation signals to power the RFID Tag 810, and a modulator 826 for modulating signals carrying the information to be transmitted to the RFID reader. The RFID tag may employ a load modulation technique to communicate the information to be transmitted to the RFID reader.

### Control Apparatus

The control apparatus 22 will now be described in more detail, by way of example only, with reference to FIG. 9, which is a simplified block schematic of the control apparatus 22.

As seen in FIG. 9, the control apparatus 22 comprises at least one sorting station interface 910, at least one reader array interface 911, at least one network interface 912, a transceiver circuit 913, a controller 914 and memory 915.

Software stored in the memory 915 includes, among other things, an operating system 916, a communication control module 917, a reader module 918, a positioning module 919, a sorting module 920, a calibration module 921, and decision logic 922. It will be appreciated that whilst, for ease of understanding, the controller 914 is described as operating under the control of a number of discrete software modules, the functionality attributed to these modules may be built into the overall operating system 916 or as separate code in such a way that the modules may not be discernible as discrete entities.

The transceiver circuit 913 is operable to send signals to, and to receive signals from: the sorting station 20 via the sorting station interface(s) 910; the antennas 30 and/or associated readers of the reader array 16 via the reader array interface(s) 911; and with an external data network (such as the internet) via the network interface(s) 912. The operation of the transceiver circuit 913 is controlled by a controller 914 in accordance with the software stored in the memory 915.

The communication control module 917 controls communication with the antennas 30 and/or associated readers of the reader array 16 to control the reader antennas 30 (and/or associated readers) of the reader array 16 in order to read the information that is stored in the respective tag 18 of each object 14 (e.g., an item specific identifier or code). The communication control module 917 also controls communication with the sorting station 20, for example to send to the sorting station 20 the instructions required for sorting each tagged item appropriately.

The communication control module 917 also controls communication with the external data network, for example to obtain information for a given tagged item (e.g., stored in a cloud-based database in association with a code corresponding to an item specific code read from transmissions received from the tag affixed to that item). For example, once a unique code associated with a particular RFID tag on an item (such as waste packaging or the like) has been acquired, that code may be compared with a suitable database of codes, for example via an internet link to a cloud storage facility, and the identity of a product associated with that item may be determined and/or other related information (e.g., other information from which a sorting destination of the tagged item can be derived such as: information on the type of product/packaging; information on the recyclability of the product/packaging; and/or information simply identifying a particular sorting bin).

It will be appreciated that whilst cloud storage and access to the product data has advantages such as allowing convenient access from any web-enabled device (e.g., a web-based client or app that allows users to visualise the items that have been detected at a specific time and location), a similar database could also be provided locally without the need for internet access.

The reader module 918 controls the emission the RF radiation emitted from the reader antennas 30 to provide the localised coverage areas R1 to R6. The reader module 918 also processes the data received from the reader array 16 to read information carried by transmissions from tagged items received via the antennas 30 of the reader array 16. The reader module 918 is also responsible for counting the respective number of transmissions received, for each tagged item, via each antenna 30. This processing may include, for example, reading a unique code associated with a tagged item and associating that code with information identifying each antenna 30 via which that information was acquired and/or information identifying the number of transmissions received for that tagged item via each antenna 30.

The positioning module 919 uses the information acquired from the transmissions from tagged items to respectively determine which antenna stream S1 to S6 and/or reader track T01 to T09/V01 to V18 each tagged item is located in. The positioning module 919 also identifies the position (in time and/or space) of each tagged item in the direction of travel of the conveyor to ensure that the timing of the sorting, performed by sorting station 20, can be controlled relatively precisely to respectively sort each tagged item appropriately at the correct timing.

The sorting module 920 is responsible for respectively obtaining appropriate item/product related information (e.g., from the external network) based on the information read from each tagged item. The sorting module 920 then controls the sorting station 20 to sort the tagged items, based on the positioning information obtained by the positioning module 919 and the item/product related information to sort the tagged items appropriately.

The calibration module 921 is responsible for controlling calibration of the system 10 in accordance with a calibration procedure (e.g., as described with reference to FIG. 7 and elsewhere).

The decision logic 922 comprises the logic used by the positioning module 919 to determine which antenna stream S1 to S6 and/or reader track T01 to T09/V01 to V18 each tagged item is located in (e.g., one or more decision matrices as described with reference to FIG. 6 and elsewhere).

### Modifications and Alternatives

A detailed embodiment and a number of possible variations has been described above. As those skilled in the art will appreciate, a number of modifications and alternatives can be made to the above embodiment and variations whilst still benefiting from the inventions embodied therein.

For example, it will be appreciated that, whilst two or more banks of reader antennas may be arranged, as described above, to provide overlapping antenna streams and associated additional spatial resolution, a similar effect could be achieved by modulating the lateral position of the coverage areas provided by the antennas, of a single bank, in time. For example, the reader array could be configured to mechanically reciprocate the antennas, of a single bank, between two or more respective configurations in which the lateral positions of the antennas, and hence the associated coverage areas, moves. In this example, antenna streams associated with one of the respective configurations would ‘overlap’ longitudinally with the antenna streams associated with one or more of the other respective configurations to provide narrower reader tracks essentially as described previously. The control apparatus in a system implementing such a time-multiplexed configuration could then identify a narrower reader track in which a tagged item is located, essentially as described previously, by treating the respective set of antenna streams associated with each configuration in the same way as the respective set of antenna streams associated with each bank in the previously described examples. Moreover, it is possible that such a time-multiplexed configuration could be achieved by electronically steering the localised coverage areas instead of mechanically moving them. Whilst this approach may add additional complexity it may have benefit because the reduced number of antennas potentially allows for a more compact and possibly more cost-efficient implementation.

In another variation the different sets of antennas (corresponding to the different banks described above), could be arranged to provide corresponding sets of coverage areas at the same longitudinal position relative to the conveyor in a manner in which the antenna streams associated with one of the sets of coverage areas would ‘overlap’ longitudinally with the antenna streams associated with one or more of the other sets of coverage areas to provide narrower reader tracks essentially as described previously. However, to avoid coupling, the different sets of antennas could be switched on or off in a time multiplexed manner, or could use some other form of antenna set specific signal modulation to avoid coupling or interference.

It will also be appreciated that whilst passive RFID tags provide particular advantages in terms of simplicity, efficiency and ease of use, the tags need not be passive RFID tags in some applications. For example, in some scenarios active RFID tags could conceivably be used. Moreover, the tag could be any other machine readable tag, for example a tag comprising a quick response (QR) code, bar code, or the like, or a tag that is readable using a different communication protocol such as another near-field communication (NFC) protocol.

In one variation, the relative transverse position of a particular tag on the conveyor may be determined, at least approximately, based on differences in the respective number of transmissions counted at each of a plurality of readers and the relative transverse positions of those readers on the conveyor.

For example, if the number of transmissions counted for a particular tag by a first reader, located with its antenna centroid at a transverse distance d₁ from the edge of the conveyor, is x₁, and the number of transmissions counted for that tag by a second reader, located with its antenna centroid at a transverse distance d₂ from the edge of the conveyor, is x₂, then the tag may be estimated to be x₂/x₁ times closer to the second reader (where x₂>x₁). Specifically, the position of the tag from the conveyor edge may be estimated to be:

$${d}_{1} + \frac{( {d}_{2} - {d}_{1} . )}{( {x}_{1} + {x}_{2} )} {x}_{2}$$

Various other modifications will be apparent to those skilled in the art and will not be described in further detail here.

1. Apparatus for identifying a position of a given object of a plurality of objects being conveyed in a direction of travel through a localisation region, each object having an associated tag, the apparatus comprising:
means for receiving signals from a respective tag associated with each object, as that object is conveyed through the localisation region, wherein the means for receiving is configured to provide a plurality of coverage areas and to receive the signals from the respective tag associated with that object when that object follows a path, of a plurality of possible paths through the localisation region, that passes through at least one coverage area of the plurality of coverage areas;
means for identifying at least one coverage area of the plurality of coverage areas in which signals have been respectively received from the tag associated with the given object; and
means for determining a position of the given object to be a position corresponding to a path, of the respective plurality of possible paths through the localisation region, that passes through the at least one coverage area identified by the identifying means;
wherein at least two paths, of the plurality of possible paths, respectively pass through each coverage area of the plurality of coverage areas, and wherein the means for determining is configured to differentiate between the at least two paths, that respectively pass through each coverage area of the at least one coverage area identified by the identifying means, to determine the position of the given object.

2. Apparatus as claimed in claim 1 wherein the means for receiving is configured to provide the plurality of coverage areas in an arrangement in which each path, of the at least two paths that respectively pass through each coverage area, passes through an associated combination of one or more coverage areas of the plurality of coverage areas; and wherein the means for determining is configured to determine the position of the given object to be a path of the at least two paths that has an associated combination of one or more coverage areas that is the same as the at least one coverage area identified by the identifying means.

3. Apparatus as claimed in claim 2 wherein the means for receiving is configured to provide the plurality of coverage areas in an arrangement in which at least one path, of the at least two paths that respectively pass through each coverage area, passes through an associated combination of at least two coverage areas.

4. Apparatus as claimed in claim 2 or 3 wherein the means for receiving is configured to provide the plurality of coverage areas in an arrangement in which at least one path, of the at least two paths that respectively pass through each coverage area, passes through an associated combination comprising a single coverage area.

5. Apparatus as claimed in any preceding claim wherein the means for receiving is configured to provide the plurality of coverage areas in an arrangement in which a first at least one coverage area is offset, in a direction orthogonal to the direction of travel, from a second at least one coverage area, by an offset distance that is less than a dimension of the first at least one coverage area in the direction orthogonal to the direction of travel.

6. Apparatus as claimed in claim 5 wherein the means for receiving is configured to provide the first at least one coverage area and the second at least one coverage area in a manner in which the first at least one coverage area and the second at least one coverage area do not overlap spatially with one another.

7. Apparatus as claimed in claim 6 wherein the means for receiving is configured to provide the first at least one coverage area and the second at least one coverage area in a manner in which the first at least one coverage area and the second at least one coverage area do not overlap spatially with one another by providing the first at least one coverage area and the second at least one coverage area in an arrangement in which the first at least one coverage area and the second at least one coverage area are spatially separated in the direction of travel.

8. Apparatus as claimed in claim 6 or 7 wherein the means for receiving is configured to provide the first at least one coverage area and the second at least one coverage area in a manner in which the first at least one coverage area and the second at least one coverage area do not overlap spatially with one another by separating provision of the first at least one coverage area and of the second at least one coverage area in time.

9. Apparatus as claimed in any of claims 5 to 8 wherein the means for receiving is configured to provide the plurality of coverage areas in an arrangement in which the first at least one coverage area comprises a plurality of coverage areas that are spatially separated from one another, in a direction orthogonal to the direction of travel, by a separation distance that is less than the offset distance.

10. Apparatus as claimed in any of claims 5 to 9 wherein the means for receiving is configured to provide the plurality of coverage areas in an arrangement in which the offset distance is approximately half the dimension of the first at least one coverage area in the direction orthogonal to the direction of travel.

11. Apparatus as claimed in any preceding claim wherein the means for determining is configured to determine a respective position of each of the plurality of objects based on information mapping each path, of the plurality of possible paths through the localisation region, to the at least one coverage area of the plurality of coverage areas through which that path passes.

12. Apparatus as claimed in any preceding claim wherein the means for determining is configured to respectively acquire information representing a number of times that a signal is received from the tag associated with the given object as the given object passes through a corresponding coverage area.

13. Apparatus as claimed in claim 12 wherein the means for determining is configured to differentiate between the at least two paths, that respectively pass through each coverage area of the at least one coverage area identified by the identifying means, based on the number of times that a signal is received from the tag associated with the given object as the given object passes through that coverage area.

14. Apparatus as claimed in claim 12 or 13 wherein the means for determining is configured to determine a respective position of each of the plurality of objects based on information for mapping each path, of the plurality of possible paths through the localisation region, that passes through a corresponding coverage area to a respective range of possible numbers of times that a signal will be received from a tag associated with an object as that object passes through that corresponding coverage area.

15. Apparatus as claimed in claim 14 wherein each range of possible numbers of times that a signal will be received from a tag associated with an object, as that object passes through that corresponding coverage area, is delimited by at least one threshold value corresponding to an upper or lower end of the range of possible numbers of times.

16. Apparatus as claimed in any of claims 12 to 15 wherein the means for determining is configured to determine an orientation of the object based on the number of times that a signal is received from the tag associated with the given object as the given object passes through that coverage area.

17. Apparatus as claimed in claim 16 wherein the means for determining is configured to determine the orientation of the object based on information for mapping each orientation, of a plurality of possible orientations, to a respective range of possible numbers of times that a signal will be received from a tag associated with an object as that object passes through a corresponding coverage area.

18. Apparatus as claimed in any preceding claim wherein the apparatus further comprises means for reading information carried by the signals received from the respective tag associated with each object of the plurality of objects and for discriminating between the given object and the other objects being conveyed in the direction of travel through the localisation region based on the information carried by the signals received from the respective tag associated with each object.

19. Apparatus as claimed in claim 18 wherein the means for determining is configured to determine a respective position of each of the plurality of objects and wherein the apparatus further comprises means for generating control signals for sorting the plurality of objects based on the respective information carried by the signals received from the respective tag associated with each object and read by the reading means, and the respective position determined for each object.

20. Apparatus as claimed in claim 18 or 19 further comprising means for selectively separating the given object from at least one other object conveyed in the direction of travel through the localisation region based on the discriminating.

21. Apparatus as claimed in any preceding claim wherein the tag is a radio frequency identification (RFID) tag and wherein the means for receiving is configured for receiving RFID signals from the RFID tag.

22. Apparatus as claimed in claim 21 wherein the tag is a passive RFID tag and wherein the means for receiving is configured to provide each coverage area of the plurality of coverage areas by illuminating the coverage area with an RFID signal for activating the passive RFID tag.

23. Apparatus as claimed in any preceding claim wherein the means for receiving comprises a plurality of antennas each antenna being configured to provide a respective coverage area of the plurality of coverage areas.

24. A method of identifying a position of a given object of a plurality of objects being conveyed in a direction of travel through a localisation region, each object having an associated tag, the apparatus comprising:
receiving, at means for receiving, signals from a respective tag associated with each object, as that object is conveyed through the localisation region, wherein the means for receiving is configured to provide a plurality of coverage areas and to receive the signals from the respective tag associated with that object when that object follows a path, of a plurality of possible paths through the localisation region, that passes through at least one coverage area of the plurality of coverage areas;
identifying at least one coverage area of the plurality of coverage areas in which signals have been respectively received from the tag associated with the given object; and
determining a position of the given object to be a position corresponding to a path, of the respective plurality of possible paths through the localisation region, that passes through the at least one coverage area identified by the identifying means;
wherein at least two paths, of the plurality of possible paths, respectively pass through each coverage area of the plurality of coverage areas, and wherein the means for determining is configured to differentiate between the at least two paths, that respectively pass through each coverage area of the at least one coverage area identified by the identifying means, to determine the position of the given object.
